(19) United States
(12) Patent Application Publication
(10) Pub. No.: US 2002/0093518 A1
(43) Pub. Date: Jul. 18, 2002

(54) Image processing apparatus, image processing method and recording medium

(76) Inventor: Masaki Nakano, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/042,231

(22) Filed: Jan. 11, 2002

(30) Foreign Application Priority Data
Jan. 18, 2001 (JP) 010665/2001 (PAT.

(51) Int. Cl. G06K 9/36; G06K 9/32; G09G 5/00

(52) U.S. Cl. 345/643; 382/284; 382/299

(57) ABSTRACT

In an image processing apparatus, when the image quality is adjusted, an image before performing an adjustment operation, a default adjustment image and an image to be adjusted are simultaneously displayed, and images of the same video source are simultaneously displayed by a multiscreen display according to a multiscreen synthesis function in order that the image quality adjustment operation can be easily performed.

### BACKGROUND OF THE INVENTION

1. Field of the Invention

The present invention relates to image processing apparatus and method having a new function, and a recording medium storing a program to achieve the above method.

2. Related Background Art

Conventionally, an image processing apparatus such as a TV set or the like has various image quality adjustment functions related to hue, chromaticity, contrast, lightness and the like on a displayed image.

However, in the image quality adjustment in this kind of conventional image processing apparatus, it is hard to objectively know effect, difference or the like in the adjustment, therefore, there is a problem that it is hard to judge whether or not the optimum adjustment was performed.

### SUMMARY OF THE INVENTION

The present invention is made in consideration of the above-mentioned problem, and an object thereof is to provide convenience in performing image quality adjustment by simultaneously displaying a preadjustment image, a default adjustment image and an adjustment image when the image quality adjustment such as adjustment of contrast, color balance or the like is performed in an image processing apparatus.

To achieve the above object, the invention according to a first aspect is characterized by an image processing apparatus comprising: a multiscreen synthesis means for composing one screen by executing a trimming process to a part of an input image and arranging plural pieces of that image; an image quality adjustment value storage means for storing image quality adjustment values for plural kinds of image quality adjustment processes; an image quality adjustment process means for executing the image quality adjustment processes for plural images on the basis of the image quality adjustment values stored in the image quality adjustment value storage means; and a control means for converting an input image into a first image to which an image quality adjustment process was executed by the image quality adjustment process means on the basis of an image quality adjustment value before performing an image quality adjustment operation stored in the image quality adjustment value storage means, and similarly converting the input image into a second image to which an image quality adjustment process was executed by the image quality adjustment process means on the basis of an image quality adjustment value of newly performing an adjustment operation, then displaying these converted first and second images on one screen with arranged state by the multiscreen synthesis means.

To achieve the above object, the invention according to a second aspect is characterized by an image processing apparatus comprising: an image enlargement and reduction means for enlarging and reducing an input image; a multiscreen synthesis means for composing one screen by arranging plural pieces of the input image reduced by the image enlargement and reduction means; an image quality adjustment value storage means for storing image quality adjustment values for plural kinds of image quality adjustment processes; an image quality adjustment process means for executing the image quality adjustment processes for plural images on the basis of the image quality adjustment values stored in the image quality adjustment value storage means; and a control means for executing an image quality adjustment process to an input image by the image quality adjustment process means on the basis of an image quality adjustment value before performing an image quality adjustment operation stored in the image quality adjustment value storage means and converting the input image into a first image which was reduced by the image enlargement and reduction means, and similarly executing an image quality adjustment process to the input image by the image quality adjustment process means on the basis of an image quality adjustment value of newly performing an adjustment operation and converting the input image into a second image which was reduced by the image enlargement and reduction means, then displaying these converted first and second images on one screen with arranged state by the multiscreen synthesis means.

To achieve the above object, the invention according to a third aspect is characterized by an image processing apparatus comprising: an image enlargement and reduction means for enlarging and reducing an input image; a multiscreen synthesis means for composing one screen by executing a trimming process to a part of the image reduced by the image enlargement and reduction means and arranging plural pieces of that image; an image quality adjustment value storage means for storing image quality adjustment values for plural kinds of image quality adjustment processes; an image quality adjustment process means for executing the image quality adjustment processes for plural images on the basis of each of combinations of the image quality adjustment values stored in the image quality adjustment value storage means; and a control means for executing an image quality adjustment process to an input image by the image quality adjustment process means on the basis of an image quality adjustment value before performing an image quality adjustment operation stored in the image quality adjustment value storage means and converting the input image into a first image which was reduced by the image enlargement and reduction means, and similarly executing an image quality adjustment process to the input image by the image quality adjustment process means on the basis of an image quality adjustment value of newly performing an adjustment operation and converting the input image into a second image which was reduced by the image enlargement and reduction means, then displaying these converted first and second images on one screen with arranged state by the multiscreen synthesis means.

To achieve the above object, the invention according to a fourth aspect is characterized by an image processing method comprising: a multiscreen synthesis step of composing one screen by executing a trimming process to a part of an input image and arranging plural pieces of that image; an image quality adjustment value storage step of storing image quality adjustment values for plural kinds of image quality adjustment processes; and an image quality adjustment process step of executing the image quality adjustment processes for plural images on the basis of each of combinations of the image quality adjustment values stored in the image quality adjustment value storage step, wherein an input image is converted into a first image to which an image quality adjustment process was executed in the image quality adjustment process step on the basis of an image quality adjustment value before performing an image quality adjustment operation stored in the image quality adjustment value storage step, and similarly the input image is converted into a second image to which an image quality adjustment process was executed in the image quality adjustment process step on the basis of an image quality adjustment value of newly performing an adjustment operation, then these converted first and second images are displayed on one screen with arranged state in the multiscreen synthesis step.

To achieve the above object, the invention according to a fifth aspect is characterized by an image processing method comprising: an image enlargement and reduction step of enlarging and reducing an input image; a multiscreen synthesis step of composing one screen by arranging plural pieces of the input image reduced in the image enlargement and reduction step; an image quality adjustment value storage step of storing image quality adjustment values for plural kinds of image quality adjustment processes; and an image quality adjustment process step of executing the image quality adjustment processes for plural images on the basis of each of combinations of the image quality adjustment values stored in the image quality adjustment value storage step, wherein an image quality adjustment process is executed to an input image in the image quality adjustment process step on the basis of an image quality adjustment value before performing an image quality adjustment operation stored in the image quality adjustment value storage step and the input image is converted into a first image which was reduced in the image enlargement and reduction step, and similarly an image quality adjustment process is executed to the input image in the image quality adjustment process step on the basis of an image quality adjustment value of newly performing an adjustment operation and the input image is converted into a second image which was reduced in the image enlargement and reduction step, then these converted first and second images are displayed on one screen with arranged state in the multiscreen synthesis step.

To achieve the above object, the invention according to a sixth aspect is characterized by an image processing method comprising: an image enlargement and reduction step of enlarging and reducing an input image; a multiscreen synthesis step of composing one screen by executing a trimming process to a part of the image reduced in the image enlargement and reduction step and arranging plural pieces of that image; an image quality adjustment value storage step of storing image quality adjustment values for plural kinds of image quality adjustment processes; and an image quality adjustment process step of executing the image quality adjustment processes for plural images on the basis of each of combinations of the image quality adjustment values stored in the image quality adjustment value storage step, wherein an image quality adjustment process is executed to an input image in the image quality adjustment process step on the basis of an image quality adjustment value before performing an image quality adjustment operation stored in the image quality adjustment value storage step and the input image is converted into a first image which was reduced in the image enlargement and reduction step, and similarly an image quality adjustment process is executed to the input image in the image quality adjustment process step on the basis of an image quality adjustment value of newly performing an adjustment operation and the input image is converted into a second image which was reduced in the image enlargement and reduction step, then these converted first and second images are displayed on one screen with arranged state in the multiscreen synthesis step.

To achieve the above object, the invention according to a seventh aspect is characterized by a recording medium which records a program for controlling an image processing apparatus by a computer, wherein the program causes the computer to convert an input image into a first image to which an image quality adjustment process was executed on the basis of a stored image quality adjustment value before performing an image quality adjustment operation, and into a second image to which an image quality adjustment process was executed on the basis of an image quality adjustment value of newly performing an adjustment operation; and execute a trimming process to parts of the converted first and second images to display obtained image pieces on one screen with arranged state.

To achieve the above object, the invention according to an eighth aspect is characterized by a recording medium which records a program for controlling an image processing apparatus by a computer, wherein the program causes the computer to execute an image quality adjustment process to an input image on the basis of a stored image quality adjustment value before performing an image quality adjustment operation and convert the input image into a first image which was reduced, and execute an image quality adjustment process to the input image on the basis of an image quality adjustment value of newly performing an adjustment operation and convert the input image into a second image which was reduced; and display the converted first and second images on one screen with arranged state.

To achieve the above object, the invention according to a ninth aspect is characterized by a recording medium which records a program for controlling an image processing apparatus by a computer, wherein the program causes the computer to execute an image quality adjustment process to an input image on the basis of a stored image quality adjustment value before performing an image quality adjustment operation and convert the input image into a first image which was reduced, and execute an image quality adjustment process to the input image on the basis of an image quality adjustment value of newly performing an adjustment operation and convert the input image into a second image which was reduced; and execute a trimming process to each part of the converted first and second images to display obtained image pieces on one screen with arranged state.

Other functions and features of the invention will become apparent from the following embodiments based on the attached drawings.

### BRIEF DESCRIPTION OF THE DRAWINGS

FIG. 1 is a block diagram showing the structure of an image processing apparatus in the first embodiment;

FIG. 2 is a schematic view of a displayed image in the first embodiment;

FIG. 3 is a flow chart showing a processing procedure in the first embodiment;

FIG. 4 is a schematic view of a displayed image in the second embodiment;

FIG. 5 is a schematic view of a displayed image in the third embodiment;

FIG. 6 is a block diagram showing the structure of an image processing apparatus in the fourth embodiment; and

FIG. 7 is a schematic view of a displayed image in the fourth embodiment.

### DETAILED DESCRIPTION OF THE PREFERRED EMBODIMENTS

First Embodiment

FIG. 1 shows the structure of an image processing apparatus in the first embodiment to which the present invention is applied. In FIG. 1, numeral 1 denotes a resolution converter acts as an image enlargement and reduction means. Numeral 6 denotes an image input terminal for inputting a digital video signal. Numeral 21 and 22 respectively denote first and second image data operation blocks act as an image quality adjustment process means. Numeral 31 and 32 denote nonvolatile memories such as first and second EEPROM's (Electrically Erasable Programmable Read-Only Memories) or the like act as an image quality adjustment value storage means.

Numeral 4 denotes a screen synthesis block acts as a multiscreen synthesis means. Numeral 5 denotes a display used for displaying images. Numeral 71 and 72 denote first and second frame memories function as buffers for temporarily storing image data. Numeral 74 denotes an OSD signal generator for generating a signal of an OSD (On Screen Display) which visually displays various operation states or the like for an operator. Numeral 75 denotes an operation key block used for performing various operations by the operator. Numeral 76 denotes a CPU (Central Processing Unit) which controls the entire of the image processing apparatus and takes an interface with the operator.

The operation key block 75 detects various keys operations according to operations performed by the operator and notifies related key data to the CPU 76. Upon receiving the data input, the CPU 76 controls the entire of an image display apparatus including the resolution converter 1, the first and second nonvolatile memories 31 and 32, the OSD signal generator 74 and other circuit blocks (not shown).

Image data input from the image input terminal 6 is reduced to half the size of the original size in longitudinal and lateral directions by the resolution converter 1 and once stored in the frame memories 71 and 72. Subsequently, an operation process regarding an image quality adjustment is executed to the reduced image data output from the frame memories 71 and 72 on the basis of image quality adjustment values stored in the first and second nonvolatile memories 31 and 32 in the first and second image data operation blocks 21 and 22. As the image quality adjustment values, for example, various values such as lightness, contrast, chromaticity, hue, RGB (red, green and blue) balance, color temperature, gamma characteristics, sharpness (emphasis) and the like or combinations of these values correspond to the image quality adjustment value.

The image quality adjustment value just before starting an image quality adjustment operation is stored in the first nonvolatile memory 31 and the image quality adjustment value in performing the image quality adjustment operation by the operation key block 75 is stored in the second nonvolatile memory 32 by an instruction from the CPU 76.

The screen synthesis block 4 arranges the image data from the image data operation block 21 on a central position in a left half area in a display screen, the image data from the image data operation block 22 on a central position in a right half area in the display screen and superimposes a signal from the OSD signal generator 74 on a central lower portion in the display screen, then the display 5 forms images to which a multiscreen synthesis process was executed.

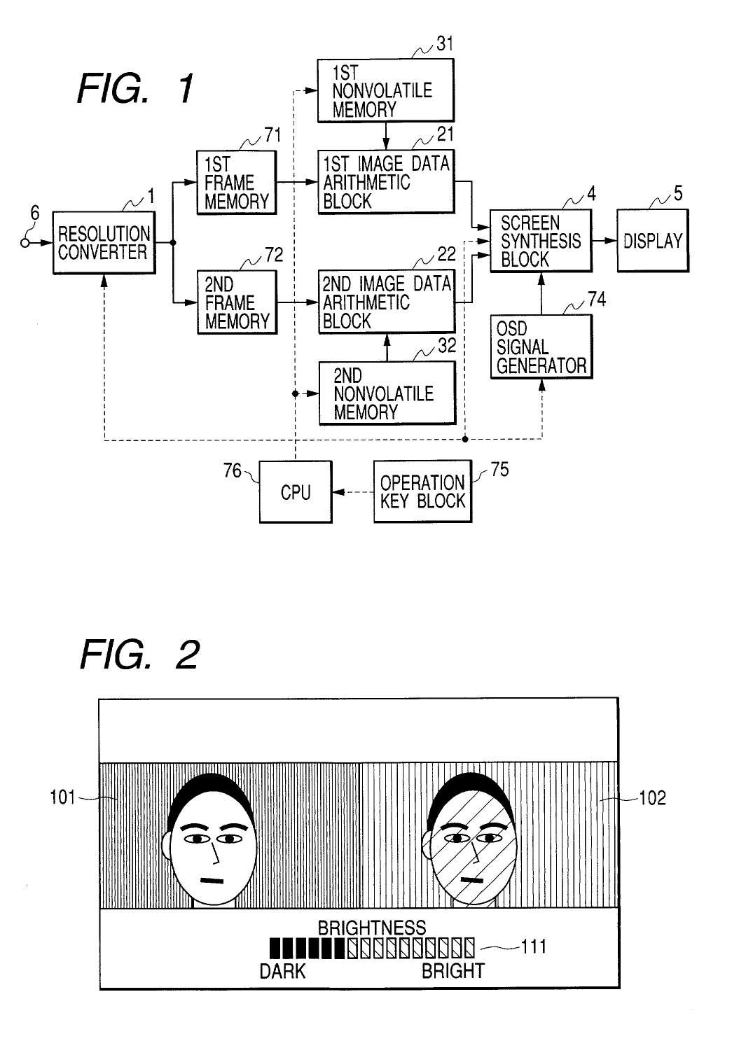

FIG. 2 schematically illustrates the display screen of the display 5 at this time of the above state. In FIG. 2, numeral 101 denotes an image just before starting the image quality adjustment operation, numeral 102 denotes an image in performing the image quality adjustment operation and numeral 111 denotes an image quality adjustment display according to the OSD signal generator 74.

In this case, state of performing an adjustment operation of “lightness” to the image 102 displayed on a right side in the screen while comparing it with the image 101 just before starting the image quality adjustment operation displayed on a left side in the screen is indicated. It should be noted that the reason for giving an adjustment of the “lightness” as an example depends on a fact that the purpose of the present invention has to be illustrated more comprehensible in this description of expressing images in monochrome, and the adjustment is not limited to the lightness. For example, operations of various image quality adjustments such as contrast, chromaticity, hue, RGB balance, color temperature, gamma characteristics, sharpness (emphasis) and the like can be performed.

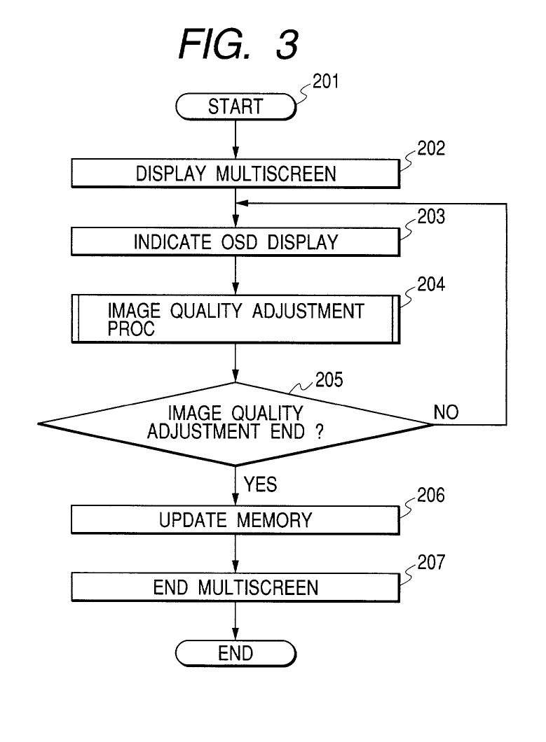

Next, a sequence (processing procedure) of the CPU 76 related to the image quality adjustment will be explained. A flow chart shown in FIG. 3 schematically shows a flow when the CPU 76 performs the image quality adjustment operation.

At first, after starting the flow in a step 201, when the operator selects an image quality adjustment mode using the operation key block 75, it is shifted to a multiscreen display mode as shown in FIG. 2 in a step 202.

Then, a display process based on the OSD is executed in a step 203, an image quality adjustment value update process of the second nonvolatile memory 32 is executed in accordance with an instruction from the operation key block 75 in a step 204 and a checking process of an image quality adjustment mode terminating instruction from the operation key block 75 is executed in a step 205. If the image quality adjustment mode terminating instruction does not exist, the flow returns to the step 203 and the above processes are repeated.

In the step 205, if the image quality adjustment mode terminating instruction exists, the flow advances to a step 206, where an image quality adjustment value stored in the second nonvolatile memory 32 at that time is firstly copied (mapping) to the first nonvolatile memory 31. Then, in a next step 207, the flow is returned to the display mode which is just before the multiscreen display mode shifted in the step 202 and the display according to the OSD signal generator 74 is terminated to exit from a series of the image quality adjustment sequence in a step 208.

Thus, according to the first embodiment, since the image quality adjustment operation can be performed while comparing the image to be adjusted with the image just before starting the image quality adjustment operation by displaying the image just before starting the image quality adjustment operation and the image to be adjusted, the adjustment operation can be easily performed.

Second Embodiment

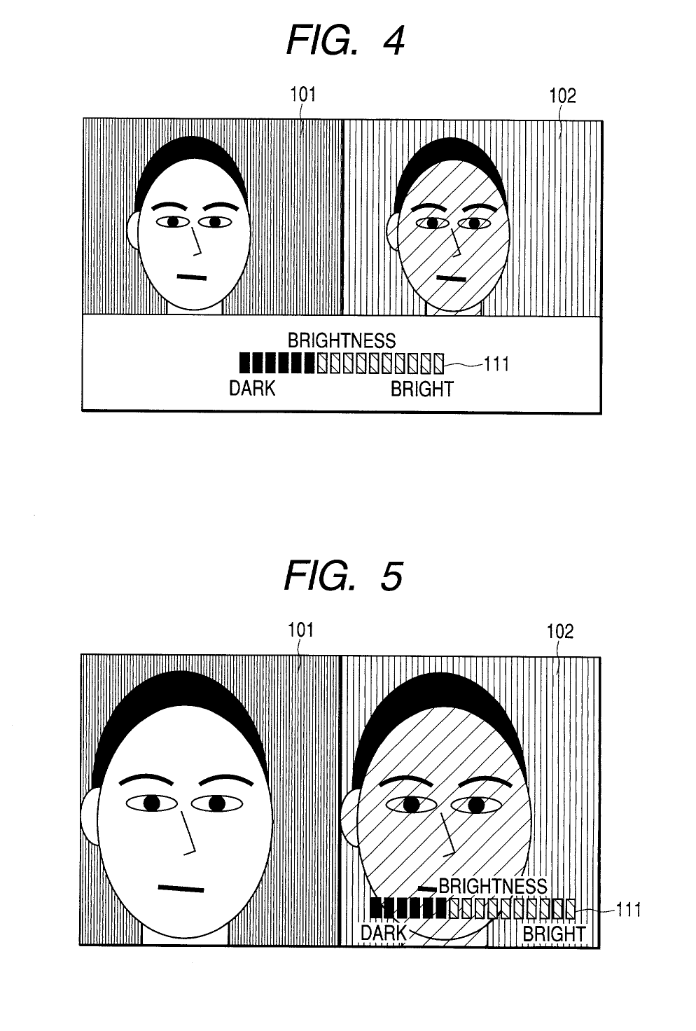

FIG. 4 schematically illustrates a display screen of a display 5 in the second embodiment to which the present invention is applied. In FIG. 4, numeral 101 denotes an image just before starting the image quality adjustment operation, numeral 102 denotes an image in performing the image quality adjustment operation and numeral 111 denotes an image quality adjustment display according to an OSD signal generator 74. That is, the same reference numerals as those in the first embodiment are given. It should be noted that since circuit blocks for realizing the second embodiment are the same as those in the first embodiment shown in FIG. 1, the detailed description thereof will be omitted.

In the second embodiment, a reduction ratio in a resolution converter 1 is set ⅔, and both sides of two images are cut out by a screen synthesis block 4, then a trimming process is executed to form images.

The trimming process of cutting out both sides of the two images may be executed at the time of executing a reduction process in the resolution converter 1 or writing image data to first and second frame memories 71 and 72.

Thus, according to the second embodiment, when the image 101 just before starting the image quality adjustment operation and the image 102 to be adjusted are displayed, an image to which the adjustment operation can be easily performed for a user is extracted by executing the trimming process to the image, then the adjustment operation can be performed using the image, therefore, the adjustment operation can be easily performed. The image to which the adjustment operation can be easily performed for the user is such an image as found in a skin color portion of a human face or the like, for example, in a case where lightness is adjusted.

Third Embodiment

FIG. 5 schematically illustrates a display screen of a display 5 in the third embodiment to which the present invention is applied. In FIG. 5, numeral 101 denotes an image just before starting the image quality adjustment operation, numeral 102 denotes an image in performing the image quality adjustment operation and numeral 111 denotes an image quality adjustment display according to an OSD signal generator 74. That is, the same reference numerals as those in the first embodiment are given. It should be noted that since circuit blocks for realizing the third embodiment are the same as those in the first embodiment shown in FIG. 1, the detailed description thereof will be omitted.

In the third embodiment, a reduction process in a resolution converter 1 is not executed and both sides of two images are cut out by a screen synthesis block 4, then a trimming process is executed to form images. The image quality adjustment display 111 according to the OSD signal generator 74 is superimposed and synthesized on the lowest position in the image 102 in performing the image quality adjustment operation.

The trimming process of cutting out both sides of the two images may be executed at the time of executing a reduction process in the resolution converter 1 or writing image data to first and second frame memories 71 and 72.

Thus, in the third embodiment, similar to the above-mentioned second embodiment, an image to which the adjustment operation can be easily performed for a user is extracted, then the adjustment operation can be performed using the image, therefore, the adjustment operation can be easily performed.

Fourth Embodiment

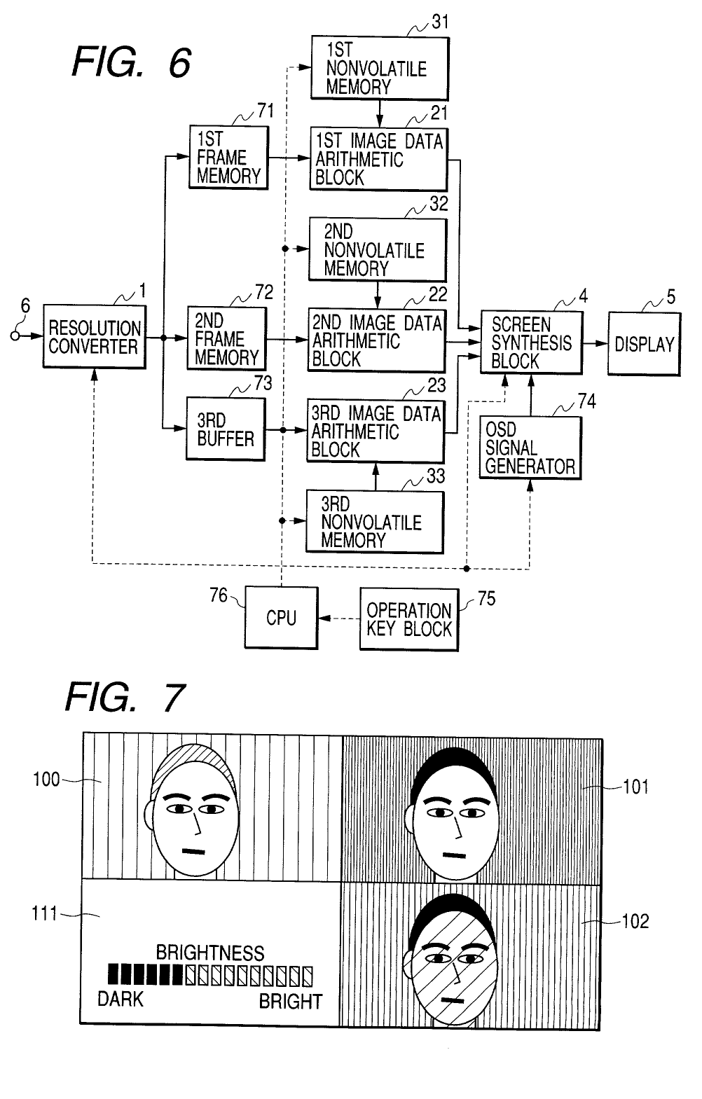

FIG. 6 shows the structure of an image processing apparatus for realizing the fourth embodiment to which the present invention is applied. In the structure shown in FIG. 6, a third image data operation block 23 acts as an image quality adjustment process means, a third nonvolatile memory 33 acts as an image quality adjustment value storage means and a third buffer (frame memory) 73 for temporarily storing image data are respectively added to the circuit structure shown in FIG. 1 in the first embodiment so as to provide three systems in total. Since the functions of each of the blocks are same as those shown in FIG. 1 in the first embodiment, the detailed description thereof will be omitted.

The third nonvolatile memory 33 which is newly added stores a default value previously set when the image processing apparatus was shipped or forwarded. In the ordinary operating state, a CPU 76 can not update this default value.

In the fourth embodiment, a reduction ratio in a resolution converter 1 is set ½, and the image data from a first image data operation block 21 is arranged on a right upper position in a display screen by a screen synthesis block 4, the image data from a second image data operation block 22 is arranged on a right lower position in the display screen and the image data from the third image data operation block 23 is arranged on a left upper position in the display screen respectively, and a signal from an OSD signal generator 74 is superimposed on a felt lower position in the display screen, then a display 5 forms the image to which a multiscreen synthesis process was executed.

FIG. 7 schematically illustrates the display screen of the display 5 at this time of the above-mentioned state. In FIG. 7, numeral 101 denotes an image just before starting the image quality adjustment operation, numeral 102 denotes an image in performing the image quality adjustment operation and numeral 111 denotes an image quality adjustment display according to the OSD signal generator 74. That is, the same reference numerals as those in the first embodiment are given. In FIG. 7, numeral 100 denotes an image to which an image adjustment process was executed on the basis of the default value of the image quality adjustment value stored in the third nonvolatile memory 33.

Therefore, the standard image 100 based on the image quality adjustment default value is displayed on a left upper position in the display screen and the image 101 just before starting the image quality adjustment operation is displayed on a right upper position in the display screen, and an operator performs an image quality adjustment operation to the image 102 displayed on a right lower position in the screen while comparing it with the above-mentioned images.

Thus, according to the fourth embodiment, an adjustment operation of the image can be performed while comparing the standard image of the image quality adjustment default value with the image just before starting the image quality adjustment operation by displaying the standard image of the image quality adjustment default value, the image just before starting the image quality adjustment operation and the image to be adjusted with arranged state, therefore, the adjustment operation can be easily performed.

Other Embodiments

In the above first to fourth embodiments according to the present invention, the image data operation blocks 21, 22 and 23 were provided on the following stages of the resolution converter 1. However, mutual positions between the image data operation blocks and the resolution converter 1 may be replaced, and image data to which the image quality adjustment processes were executed by those image data operation blocks may be respectively reduced by exclusive resolution converters.

Further, image data operation blocks capable of executing adjustment processes using an individual image quality adjustment value every area in a screen are provided on the following stages of a multiscreen synthesis means as an image quality adjustment process means, and the image quality adjustment process may be executed for one image which is multiscreen synthesized by a screen synthesis block.

In the first to third embodiment according to the present invention, the image 101 just before starting the image quality adjustment operation and the image 102 in performing the image quality adjustment operation were displayed with arranged state. However, the standard image 100 of the image quality adjustment default value as explained in the fourth embodiment may be displayed instead of the image 101 just before starting the image quality adjustment operation.

Further, a method of selecting any one image from the standard image 100 of the image quality adjustment default value or the image 101 just before starting the image quality adjustment operation by an operator and displaying the selected one image as a reference image is also considered.

In any of the above-mentioned embodiments according to the present invention, the arrangement of the reference image and the image 102 in performing the image quality adjustment operation is not limited to the arrangements as shown in FIGS. 2, 4, 5 and 7, and a reduction ratio for the both images and the trimming quantity may be changed.

In any of the above-mentioned embodiments according to the present invention, a digital video signal is used as an input image signal. However, it is needless to say that an effect of the present invention does not change in a case where the adjustment process is executed after an analog video signal is A/D (analog-to-digital) converted or an analog process is executed to the image quality adjustment process means itself.

The present invention is applicable to a system composed of plural equipments (e.g., a host computer, an interface equipment, a reader, a printer, and the like) or to an apparatus including a single equipment (e.g., a digital TV receiver, a video camera, a video editing apparatus, and the like).

It is needless to say that an object of the present invention can be achieved in a case where a recording medium (storage medium) recording the program codes of a software for realizing the functions of the above-mentioned embodiments is supplied to a system or an apparatus and then a computer (or CPU or MPU) in the system or the apparatus reads and executes the program codes stored in the recording medium.

In this case, the program codes themselves read from the recording medium realize the functions of the above-mentioned embodiments, and the recording medium recording such the program codes constitutes the present invention.

The recording medium recording the program codes and conversion data such as a table or the like can be, for example, an FD (Floppy Disk), a hard disk, an optical disk, a magnetooptical disk, a CD-ROM (Compact Disk Read-Only Memory), a CD-R (Compact Disk Recordable), a magnetic tape, a nonvolatile memory card (IC (Integrated Circuit) card), a ROM or the like.

It is needless to say that the present invention also includes not only a case where the functions of the above-mentioned embodiments are realized by the execution of the program codes read by the computer, but also a case where an OS (Operating System) or the like functioning on the computer executes all the process or a part thereof according to the instructions of the program codes, thereby realizing the functions of the above-mentioned embodiments by the executed processes.

As explained above, since an input image is reduced and an image in performing the image adjustment operation is to be displayed arranged with a standard image or an image before performing an adjustment operation treated as a reference image, an effect that difference in the adjustment can be easily recognized and a delicate image quality adjustment operation can be easily performed is obtained.

What is claimed is:

1. An image processing apparatus comprising:
multiscreen synthesis means for composing one screen by executing a trimming process to a part of an input image and arranging plural pieces of that image;
image quality adjustment value storage means for storing image quality adjustment values for plural kinds of image quality adjustment processes;
image quality adjustment process means for executing the image quality adjustment processes for plural images on the basis of the image quality adjustment values stored in said image quality adjustment value storage means; and
control means for converting an input image into a first image to which an image quality adjustment process was executed by said image quality adjustment process means on the basis of an image quality adjustment value before performing an image quality adjustment operation stored in said image quality adjustment value storage means, and similarly converting the input image into a second image to which an image quality adjustment process was executed by said image quality adjustment process means on the basis of an image quality adjustment value of newly performing an adjustment operation, then displaying the converted first and second images on one screen with arranged state by said multiscreen synthesis means.

2. An image processing apparatus comprising:
image enlargement and reduction means for enlarging and reducing an input image;
multiscreen synthesis means for composing one screen by arranging plural pieces of the input image reduced by said image enlargement and reduction means;
image quality adjustment value storage means for storing image quality adjustment values for plural kinds of image quality adjustment processes;
image quality adjustment process means for executing the image quality adjustment processes for plural images on the basis of the image quality adjustment values stored in said image quality adjustment value storage means; and
control means for executing an image quality adjustment process to an input image by said image quality adjustment process means on the basis of an image quality adjustment value before performing an image quality adjustment operation stored in said image quality adjustment value storage means and converting the input image into a first image which was reduced by said image enlargement and reduction means, and similarly executing an image quality adjustment process to the input image by said image quality adjustment process means on the basis of an image quality adjustment value of newly performing an adjustment operation and converting the input image into a second image which was reduced by said image enlargement and reduction means, then displaying the converted first and second images on one screen with arranged state by said multiscreen synthesis means.

3. An image processing apparatus comprising:
image enlargement and reduction means for enlarging and reducing an input image;
multiscreen synthesis means for composing one screen by executing a trimming process to a part of the image reduced by said image enlargement and reduction means and arranging plural pieces of that image;
image quality adjustment value storage means for storing image quality adjustment values for plural kinds of image quality adjustment processes;
image quality adjustment process means for executing the image quality adjustment processes for plural images on the basis of each of combinations of the image quality adjustment values stored in said image quality adjustment value storage means; and
control means for executing an image quality adjustment process to an input image by said image quality adjustment process means on the basis of an image quality adjustment value before performing an image quality adjustment operation stored in said image quality adjustment value storage means and converting the input image into a first image which was reduced by said image enlargement and reduction means, and similarly executing an image quality adjustment process to the input image by said image quality adjustment process means on the basis of an image quality adjustment value of newly performing an adjustment operation and converting the input image into a second image which was reduced by said image enlargement and reduction means, then displaying the converted first and second images on one screen with arranged state by said multiscreen synthesis means.

4. An apparatus according to claim 1, wherein images which are displayed on one screen with arranged state by said multiscreen synthesis means are two pieces, and the image quality adjustment value before performing the image quality adjustment operation stored in said image quality adjustment value storage means coincides with a value which was previously set at a time of manufacturing, and said multiscreen synthesis means displays an image to which the image quality adjustment process was executed on the basis of the value which was previously set at the time of manufacturing and an image to which the image quality adjustment process was executed on the basis of the image quality adjustment value of performing the adjustment operation on one screen with arranged state.

5. An apparatus according to claim 1, wherein images which are displayed on one screen with arranged state by said multiscreen synthesis means are two pieces, and the image quality adjustment value before performing the image quality adjustment operation stored in said image quality adjustment value storage means coincides with a value which was used just before starting the image quality adjustment operation, and said multiscreen synthesis means displays an image to which the image quality adjustment process was executed on the basis of the value which was used just before starting the image quality adjustment operation and an image to which the image quality adjustment process was executed on the basis of the image quality adjustment value of performing the adjustment operation on one screen with arranged state.

6. An apparatus according to claim 1, wherein images which are displayed with arranged state by said multiscreen synthesis means are two pieces, and any one value can be selected from a value which was previously set at a time of manufacturing or a value which was used just before starting the image quality adjustment operation as the image quality adjustment value before performing the image quality adjustment operation stored in said image quality adjustment value storage means, and said multiscreen synthesis means displays any one image from an image to which the image quality adjustment process was executed on the basis of the value which was previously set at the time of manufacturing or an image to which the image quality adjustment process was executed on the basis of the value which was used just before starting the image quality adjustment operation and an image to which the image quality adjustment process was executed on the basis of the image quality adjustment value of performing the adjustment operation on one screen with arranged state.

7. An apparatus according to claim 1, wherein images which are displayed with arranged state by said multiscreen synthesis means are three pieces, and the image quality adjustment values before performing the image quality adjustment operation stored in said image quality adjustment value storage means are two values which were previously set at a time of manufacturing and used just before starting the image quality adjustment operation, and said multiscreen synthesis means displays three pieces of an image to which the image quality adjustment process was executed on the basis of the value which was previously set at the time of manufacturing, an image to which the image quality adjustment process was executed on the basis of the value which was used just before starting the image quality adjustment operation and an image to which the image quality adjustment process was executed on the basis of the image quality adjustment value of performing the adjustment operation on one screen with arranged state.

8. An apparatus according to claim 1, further comprising operation means for arbitrarily setting a reduction ratio in said image enlargement and reduction means and image arrangement or trimming position in said multiscreen synthesis means.

9. An image processing method comprising:
a multiscreen synthesis step of composing one screen by executing a trimming process to a part of an input image and arranging plural pieces of that image;
an image quality adjustment value storage step of storing image quality adjustment values for plural kinds of image quality adjustment processes; and
an image quality adjustment process step of executing the image quality adjustment processes for plural images on the basis of each of combinations of the image quality adjustment values stored in said image quality adjustment value storage step,
wherein an input image is converted into a first image to which an image quality adjustment process was executed in said image quality adjustment process step on the basis of an image quality adjustment value before performing an image quality adjustment operation stored in said image quality adjustment value storage step, and similarly the input image is converted into a second image to which an image quality adjustment process was executed in said image quality adjustment process step on the basis of an image quality adjustment value of newly performing an adjustment operation, then the converted first and second images are displayed on one screen with arranged state in said multiscreen synthesis step.

10. An image processing method comprising:
an image enlargement and reduction step of enlarging and reducing an input image;
a multiscreen synthesis step of composing one screen by arranging plural pieces of the input image reduced in said image enlargement and reduction step;
an image quality adjustment value storage step of storing image quality adjustment values for plural kinds of image quality adjustment processes; and
an image quality adjustment process step of executing the image quality adjustment processes for plural images on the basis of each of combinations of the image quality adjustment values stored in said image quality adjustment value storage step,
wherein an image quality adjustment process is executed to an input image in said image quality adjustment process step on the basis of an image quality adjustment value before performing an image quality adjustment operation stored in said image quality adjustment value storage step and the input image is converted into a first image which was reduced in said image enlargement and reduction step, and similarly an image quality adjustment process is executed to the input image in said image quality adjustment process step on the basis of an image quality adjustment value of newly performing an adjustment operation and the input image is converted into a second image which was reduced in said image enlargement and reduction step, then the converted first and second images are displayed on one screen with arranged state in said multiscreen synthesis step.

11. An image processing method comprising:
an image enlargement and reduction step of enlarging and reducing an input image;
a multiscreen synthesis step of composing one screen by executing a trimming process to a part of the image reduced in said image enlargement and reduction step and arranging plural pieces of that image;
an image quality adjustment value storage step of storing image quality adjustment values for plural kinds of image quality adjustment processes; and
an image quality adjustment process step of executing the image quality adjustment processes for plural images on the basis of each of combinations of the image quality adjustment values stored in said image quality adjustment value storage step,
wherein an image quality adjustment process is executed to an input image in said image quality adjustment process step on the basis of an image quality adjustment value before performing an image quality adjustment operation stored in said image quality adjustment value storage step and the input image is converted into a first image which was reduced in said image enlargement and reduction step, and similarly an image quality adjustment process is executed to the input image in said image quality adjustment process step on the basis of an image quality adjustment value of newly performing an adjustment operation and the input image is converted into a second image which was reduced in said image enlargement and reduction step, then the converted first and second images are displayed on one screen with arranged state in said multiscreen synthesis step.

12. A recording medium which records an image display program for controlling an image processing apparatus by a computer, wherein said program causes the computer to
convert an input image into a first image to which an image quality adjustment process was executed on the basis of a stored image quality adjustment value before performing an image quality adjustment operation, and into a second image to which an image quality adjustment process was executed on the basis of an image quality adjustment value of newly performing an adjustment operation, and
execute a trimming process to parts of the converted first and second images to display obtained image pieces on one screen with arranged state.

13. A recording medium which records an image display program for controlling an image processing apparatus by a computer, wherein said program causes the computer to
execute an image quality adjustment process to an input image on the basis of a stored image quality adjustment value before performing an image quality adjustment operation and convert the input image into a first image which was reduced, and execute an image quality adjustment process to the input image on the basis of an image quality adjustment value of newly performing an adjustment operation and convert the input image into a second image which was reduced, and
display the converted first and second images on one screen with arranged state.

14. A recording medium which records an image display program for controlling an image processing apparatus by a computer, wherein said program causes the computer to
execute an image quality adjustment process to an input image on the basis of a stored image quality adjustment value before performing an image quality adjustment operation and convert the input image into a first image which was reduced, and execute an image quality adjustment process to the input image on the basis of an image quality adjustment value of newly performing an adjustment operation and convert the input image into a second image which was reduced, and
execute a trimming process to each part of the converted first and second images to display obtained image pieces on one screen with arranged state.
